(19) United States
(12) Patent Application Publication
(10) Pub. No.: US 2011/0032247 A1
(43) Pub. Date: Feb. 10, 2011

(54) DRIVING CIRCUIT AND DISPLAY SYSTEM INCLUDING THE SAME

(76) Inventors: Chiu-Hsia Hsieh, Taipei City (TW); Jun-Ren Shih, Hsinchu City (TW); Shang-Ping Tang, Hsinchu City (TW)

Correspondence Address: BIRCH STEWART KOLASCH & BIRCH, PO BOX 747, FALLS CHURCH, VA, 22040-0747, US

(21) Appl. No.: 12/821,373

(22) Filed: Jun. 23, 2010

(30) Foreign Application Priority Data
Aug. 6, 2009 (TW) 098126473

(51) Int. Cl. G09G 5/00

(52) U.S. Cl. 345/214

(57) ABSTRACT

A driving circuit for a display system is provided. The driving circuit includes two driving units. After receiving N image data, the first driving unit drives the display system based on M image data among the N image data. The second driving unit receives the other (N−M) image data and a set of control signals from the first driving unit. The second driving unit drives the display system based on the (N−M) image data and the set of control signals. The first driving unit adjusts the timing sequence of the set of control signals according to the mode of the display system.

### BACKGROUND OF THE INVENTION

1. Field of the Invention

The invention is related to display systems. In particular, the present invention relates to driving circuits for display systems.

2. Description of the Prior Art

In recent years, because of the advance in related manufacturing technologies and the reduction in manufacturing costs, display systems are widely used in personal and commercial products. How to improve the quality of display systems and make the characteristics of display systems come up to user needs have been important issues for product designers.

Please refer to FIG. 1, which illustrates an exemplary configuration of a display system 10 and its driving circuits. In this example, the display system 10 includes P rows and N columns of display units 12. P and N are positive integers. In the source driver 16, N registers are used for temporarily storing N image data (for instance, N gray levels) provided by an external signal source not shown. Each of the N registers is corresponding to one column of the display units 12. The gate driver 14 is used for sequentially turning on the display units 12 row by row. When a certain row of display units 12 is turned on, the source driver 16 provides driving voltages corresponding to the N image data to the N display units 12 in the row via circuits such as operational amplifiers.

If the display system 10 is quite large and includes lots of columns of display units 12, it is possible that a single source driving chip is unable to drive all the display units 12 at the same time because the source driving chip does not have enough pins. Therefore, the source driver 16 may consist of two or more driving chips in actual application. FIG. 2 illustrates an exemplary source driver 16 including two driving chips, first source driver 18 and second source driver 20. The exemplary source driver 16, the first source driver 18, and the second source driver 20 are source drivers with the function of timing control.

The first source driver 18 and the second source driver 20 are usually the same. Generally, the source driver physically closer to the gate driver 14 on the circuit board is referred to as the main driver. In this example, the first source driver 18 is the main driver and the second source driver 20 is the auxiliary driver. The external signal source sequentially provides N image data into the first source driver 18; N is a positive integer. Typically, the image data corresponding to the leftmost part of an image is first provided. In other words, image data corresponding to the right part of an image is sent to the first source driver 18 later than image data corresponding to the left part of the image. In this example, the first source driver 18 and the second source driver 20 respectively include (N/2) registers. After receiving the N image data, the first source driver 18 only stores (N/2) image data among the N image data. The other (N/2) image data is transmitted from the first source driver 18 to the second source driver 20.

As shown in FIG. 2, the first source driver 18 is responsible for driving the display units 12 at the left side of the display system 10. The second source driver 20 is responsible for driving the display units 12 at the right side of the display system 10. Accordingly, the preceding (N/2) image data among the N image data is usually stored into the registers of the first source driver 18; the following (N/2) image data among the N image data is usually stored into the registers of the second source driver 20.

Also as shown in FIG. 2, besides the (N/2) image data, the first source driver 18 as the main driver also provides a set of control signals generated by the control signal generating circuit 18A to the second source driver 20. The second source driver 20 drives the right part of the display system 10 based on the received (N/2) image data and the set of control signals. The control signal generating circuit 20A in the second source driver 20 may further generate one or more control signals for the second source driver 20 based on the set of control signals provided by the first source driver 18.

FIG. 3(A) and FIG. 3(B) illustrate the exemplary timing sequences of several control signals and the image data. The period “T” represents the period that the external signal source provides the first source driver 18 the image data corresponding to one row of display units 12. In other words, in each period T, one row of image data is sent to the first source driver 18. The signal “Data” represents the image data provided to the first source driver 18. The signal “Data1” represents the image data provided from the first source driver 18 to the second source driver 20.

During each period T, when the control signal DE (data enable) is in the high-level status, the external signal source transmits the N image data to the first source driver 18. The preceding (N/2) image data among the N image data is first stored into the registers of the first source driver 18. Subsequently, the following (N/2) image data among the N image data is transmitted to the second source driver 20 from the first source driver 18. The second source driver 20 receives and stores the following (N/2) image data.

The high-level status of the control signal Hz indicates the connections between the LCD driver and the display unit 12 are turned into disconnected circuits. For display systems adopting the half source-drain (HSD) structure, there are two high-level durations in the control signal “Hz” in every period T. In this example, there are voltage transitions from low to high at the middle point of period T (i.e. time instant t1) and the time instant when there is a falling edge in signal DE (i.e. time instant t2). For display systems adopting other structure, there is usually only one high-level duration in the control signal “Hz” in every period T. The control signal POL represents the polarity of the source of the display system 10 and is also related to how the first source driver 18 and the second source driver 20 control the display system 10.

It should be mentioned that the control signal DE is transmitted from the external signal source to the first source driver 18 and is not further forwarded to the second source driver 20. The control signals POL, Hz, and other signals not mentioned herein might be transmitted from the first source driver 18 to the second source driver 20.

As described above, the first source driver 18 generally receives the leftmost image data first. Under some circumstances, the display system 10 is required to flip images left to right. If the sequence of image data sent from the external signal source to the first source driver 18 is the same, the first source driver 18 and the second source driver 20 must change the sequence of storing image data, so as to achieve the effect of flipping images on the display panel.

For example, the first image data among the N image data is originally to be stored in the register corresponding to the leftmost display units 12 in the first source driver 18. To flip images on the display panel, the first image data must be stored in the register corresponding to the rightest display units 12 in the second source driver 20. FIG. 3(B) illustrates the timing sequence under this condition. As shown by the signal Data1 in FIG. 3(B), the first source driver 18 first transmits the preceding (N/2) image data among the N image data to the second source driver 20 and then stores the following (N/2) image data into its own registers.

In actual applications, the hardware arrangement of the gate driver 14, the first source driver 18, and the second source driver 20 may be designed as shown in FIG. 4. With this arrangement, if the external signal source first sends leftmost image data to the first source driver 18, the first source driver 18 must transmit the preceding (N/2) image data among the N image data to the second source driver 20, too.

The first source driver 18 and the second source driver 20 are usually disposed on the same printed circuit board or glass substrate. As known by those skilled in the art, the wires connected between the two drivers inevitably have parasitic resistance thereon. The value of the resistance is relative to the characteristic of the substrate and the formality of the routes.

The ground nodes of the first source driver 18 and the second source driver 20 are connected with each other. Being effected by the aforementioned resistance, the ground voltage of the second source driver 20 is less stable compared with that of the first source driver 18. When there is a voltage status transition on the signal transmitted from the first source driver 18 to the second source driver 20, there will be obvious noise impulses on the ground node GND of the second source driver 20 as shown in FIG. 3(A) and FIG. 3(B).

If the noise impulses appear during the duration in which the first source driver 18 stores image data into its registers, the stored image data is usually not affected. However, if the noise impulses appear during the duration in which the second source driver 20 stores image data into its registers, the judgment on voltage levels in the second source driver 20 is probably interfered by the impulses. The image data stored into the registers of the second source driver 20 might accordingly be abnormal or incorrect.

Furthermore, the voltage variations of the image data may also induce noise impulses on the ground node. The control signals transmitted from the first source driver 18 to the second source driver 20 might be interfered by impulses on the ground and have error, too. No matter being existed in the image data or the control signals, the errors will damage the image displayed on the display system 10.

For the exemplary control signals illustrated above, if the preceding (N/2) image data in the Data signal is stored into the registers in the first source driver 18 as shown in FIG. 3(A), the noise impulses happen at time instant t1 usually do not damage the data. However, if the display system is requested to flip images or the hardware arrangement of the drivers is designed as shown in FIG. 4, the preceding (N/2) image data in the Data signal will be stored into the registers of the second source driver 20 as shown in FIG. 3(B). In this situation, the noise impulses happen at time instant t1 probably damage the image data and control signals in the second source driver 20.

### SUMMARY OF THE INVENTION

To solve the aforementioned problem, the invention provides a driving circuit for the display system. By suitably adjusting the timing sequence of control signals, the situation that image data and control signals are damaged can be prevented.

One embodiment according to the invention is a driving circuit including two driving units. The first driving unit is used for receiving N image data and driving a display system based on M image data among the N image data. N and M are both positive integers. M is smaller than N. The second driving unit is electrically connected to the first driving unit and used for receiving a set of control signals and the other (N−M) image data among the N image data from the first driving unit. The second driving unit drives the display system based on the set of control signals and the (N−M) image data.

When the display system is in a first mode, the first driving unit provides the set of control signals to the second driving unit in a first timing sequence. When the display system is in a second mode, the first driving unit provides the set of control signals to the second driving unit in a second timing sequence. In other words, the first driving unit suitably adjusts the timing sequence of set of control signals based on the mode of the display system. The situations that noise impulses destroy image data and control signals can accordingly be prevented.

The advantage and spirit of the invention may be understood by the following recitations together with the appended drawings.

### BRIEF DESCRIPTION OF THE APPENDED DRAWINGS

FIG. 1, FIG. 2, and FIG. 4 illustrate the exemplary relativity of a display system and its driving circuits.

FIG. 3(A) and FIG. 3(B) illustrate the exemplary timing sequences of several control signals and the image data.

FIG. 5(A) and FIG. 5(B) show the block diagram of the driving circuit and display system according to the invention.

FIG. 6(A) and FIG. 6(B) illustrate examples of the control signals with the timing sequences according to the invention.

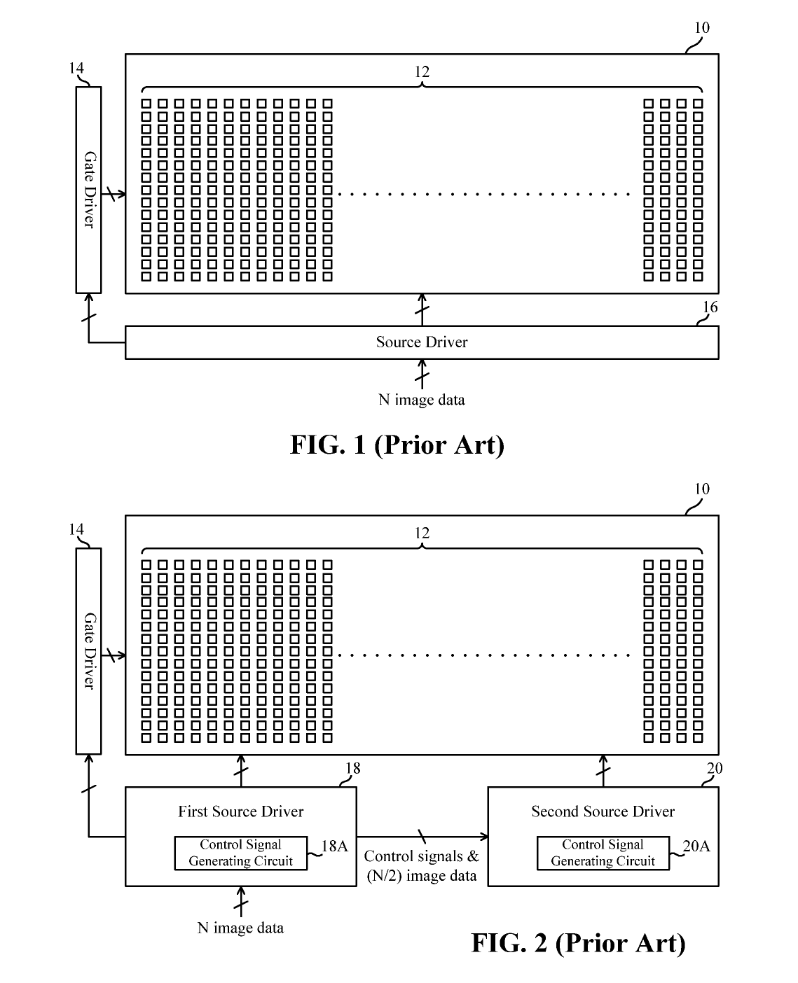

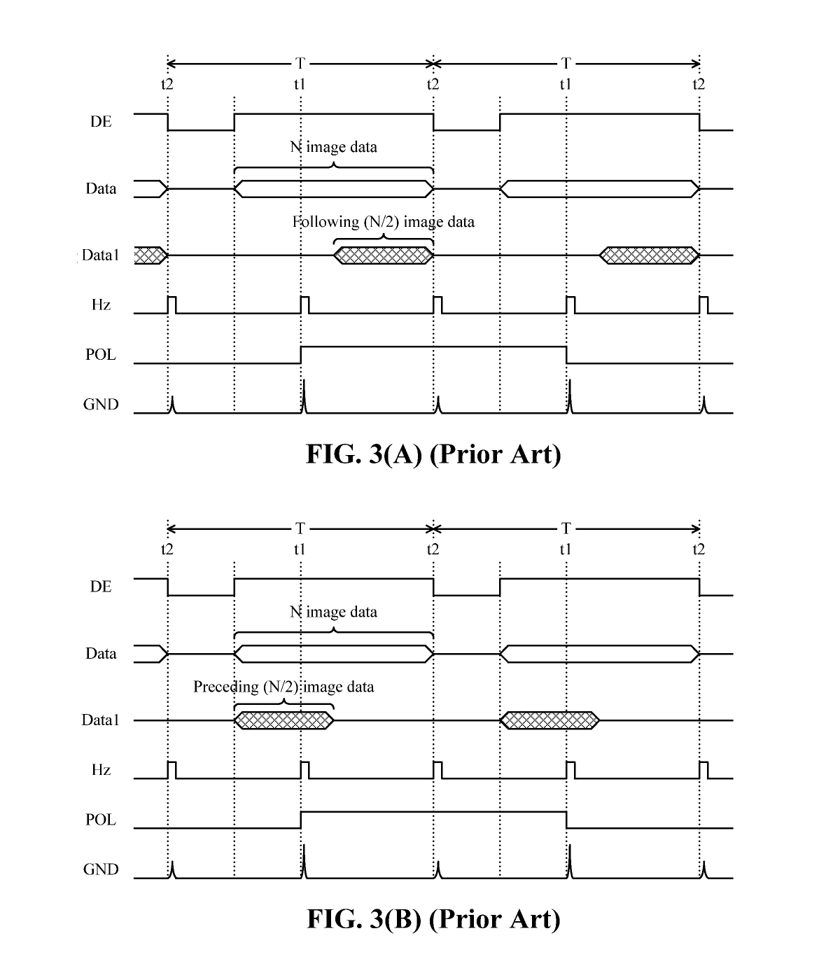

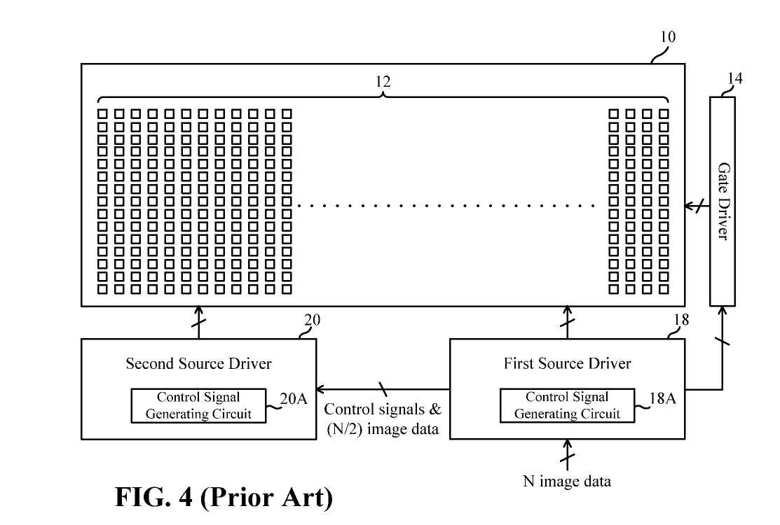

### DETAILED DESCRIPTION OF THE INVENTION

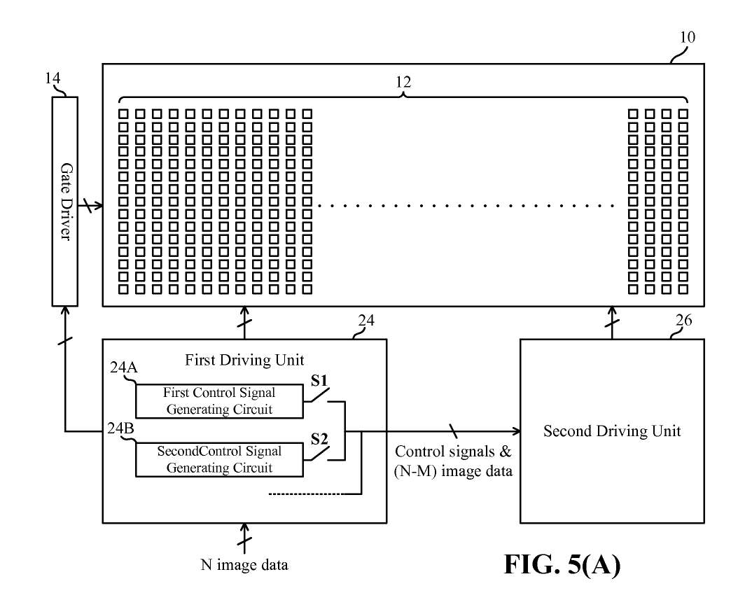

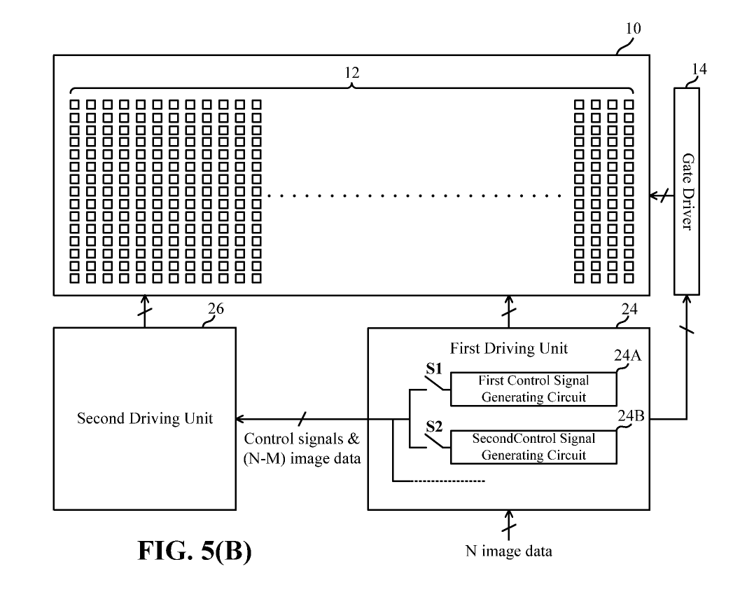

One embodiment according to the invention is a driving circuit. FIG. 5(A) shows the block diagram of the driving circuit and display system. This driving circuit includes a first driving unit 24 and a second driving unit 26. The first driving unit 24 receives N image data from an external signal source (not shown) and drives the display system 10 based on M image data among the N image data. N and M are both positive integers; M is smaller than N. For instance, N might be 1024 and M might be 512.

The second driving unit 26 is electrically connected to the first driving unit 24. The second driving unit 26 receives a set of control signals and the other (N−M) image data among the N image data from the first driving unit 24. Based on the set of control signals and the (N−M) image data, the second driving unit 26 drives the display system 10. In this embodiment, the first driving unit 24 drives the M columns of display units 12 at the left part of the display system 10; the second driving unit 26 drives the other (N−M) columns of display units 12 at the right part of the display system 10.

The aforementioned external signal source sequentially provides the N image data into the first driving unit 24. The image data corresponding to the leftmost part of an image is first sent to the first driving unit 24. In other words, image data corresponding to the right part of an image is sent to the first driving unit 24 later than image data corresponding to the left part of the image. After receiving the N image data, the first driving unit 24 only stores M image data among the N image data and transmits the other (N−M) image data to the second driving unit 26. The first driving unit 24 includes M first registers and the second driving unit 26 includes (N−M) second registers. The registers are used for temporarily storing the image data.

In this embodiment, the first driving unit 24 includes a first control signal generating circuit 24A and a second control signal generating circuit 24B. The first control signal generating circuit 24A is used for generating a set of control signals in a first timing sequence. The second control signal generating circuit 24B is used for generating a set of control signals in a second timing sequence. According to the mode of the display system 10, the first driving unit 24 determines to provide whether the set of control signals with the first timing sequence or the set of control signals with the second timing sequence to the second driving unit 26.

In practical applications, the first control signal generating circuit 24A and the second control signal generating circuit 24B can be integrated in a single circuit capable of generating two kinds of control signals.

As shown in FIG. 5(A), the first driving unit 24 can control which set of control signals are sent to the second driving unit 26 by turning on/off the switches S1 and S2. When the display system 10 is in a first mode, the first driving unit 24 provides the set of control signals generated by the first control signal generating circuit 24A to the second driving unit 26. When the display system 10 is in a second mode, the first driving unit 24 provides the set of control signals generated by the second control signal generating circuit 24B to the second driving unit 26.

For instance, the condition when the preceding M image data among the N image data must be stored into the first driving unit 24 can be defined as the display system 10 being in the first mode. On the contrary, the condition when the later M image data among the N image data must be stored into the first driving unit 24 can be defined as the display system 10 being in the second mode.

More specifically, when the display system 10 is in the first mode, the first driving unit 24 stores the preceding M image data among the N image data into the M first registers in a first duration and then provides the following (N−M) image data among the N image data to the second driving unit 26 in a second duration. When the display system 10 is in the second mode, the first driving unit 24 provides the preceding (N−M) image data among the N image data to the second driving unit 26 in a first duration. After the second driving unit 26 stores the (N−M) image data into the (N−M) second registers, the first driving unit 24 stores the following M image data among the N image data into the M first registers in a second duration.

When the hardware arrangement of the gate driver 14, the first driving unit 24, and the second driving unit 26 is designed as that shown in FIG. 5(A), the preceding M image data among the N image data will be stored into the first driving unit 24 if the display system 10 is not requested to flip images. Further, when the hardware relationship between the gate driver 14, the first driving unit 24, and the second driving unit 26 is designed as that shown in FIG. 5(B), the preceding M image data among the N image data will also be stored into the first driving unit 24 if the display system 10 is requested to flip images. Accordingly, the display system 10 is in the aforementioned first mode under these two conditions described in this paragraph.

On the contrary, when the hardware arrangement of the gate driver 14, the first driving unit 24, and the second driving unit 26 is designed as that shown in FIG. 5(A), the preceding (N−M) image data among the N image data will be stored into the second driving unit 26 if the display system 10 is requested to flip images. Further, when the hardware arrangement of the gate driver 14, the first driving unit 24, and the second driving unit 26 is designed as that shown in FIG. 5(B), the preceding (N−M) image data among the N image data will also be stored into the second driving unit 26 if the display system 10 is not requested to flip images. Accordingly, the display system 10 is in the aforementioned second mode under the two conditions described in this paragraph.

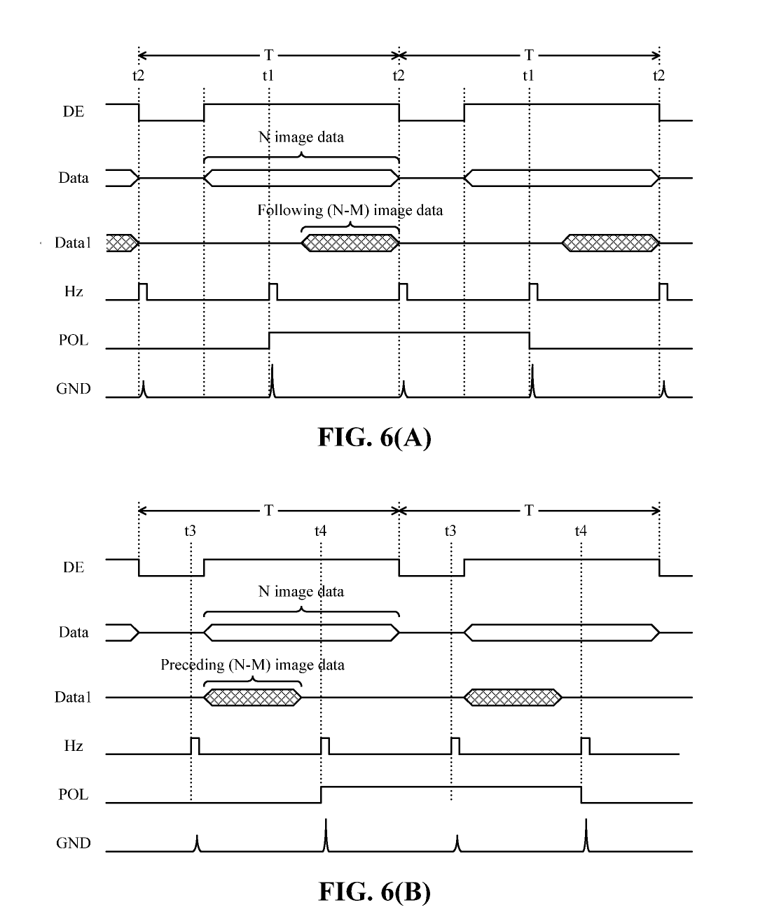

FIG. 6(A) illustrates an example of the set of control signals with the first timing sequence. The period “T” represents the period that the external signal source provides the first driving unit 24 the image data corresponding to each one row of display units 12. The signal “Data” represents the image data provided to the first driving unit 24. The signal “Data1” represents the image data provided from the first driving unit 24 to the second driving unit 26.

In this example, there are two high-level statuses in the control signal “Hz” in every period T. It can be seen the transition edges of the Hz signal are arranged near the middle point of period T (i.e. time instant t1) and the time instant when there is a falling edge in signal DE (i.e. time instant t2). The transition edges of the POL signal are arranged near time instant t1. As shown in FIG. 6(A), the transition edges of the control signals Hz and POL with the first timing sequence all appear outside the second duration that the first driving unit 24 provides the following (N−M) image data to the second driving unit 26.

FIG. 6(A) illustrates an example of the set of control signals with the second timing sequence. In this example, the high-level statuses of the Hz signal are arranged before the time when there is a rising edge in the DE signal (i.e. time instant t3) and at the middle point between two time instants t3 (i.e. time instant t4). The transition edges of the control signal POL are arranged at time instant t4. As shown in FIG. 6(B), the transition edges of the control signals Hz and POL with the first timing sequence all appear outside the first duration that the first driving unit 24 provides the preceding (N−M) image data to the second driving unit 26.

Besides the exemplary control signals Hz and POL, the control signals sent from the first driving unit 24 to the second driving unit 26 may also include clock signal or other signals. In the above examples, no matter the display system 10 is in the first or second mode, the transition edges of the control signals are arranged outside the durations that the first driving unit 24 provides image data to the second driving unit 26. Therefore, the noise impulses at the ground node induced by the control signals also happen outside the duration that the second driving unit 26 receives image data.

As described above, if the noise impulses happen in the duration that the first driving unit 24 stores image data into its own registers, the image data is usually not effected. However, if the noise impulses happen in the duration that the second driving unit 26 stores image data into its registers, the noise impulses may affect the judgment of voltage levels in the second driving unit 26 and further induce data errors in the registers.

By arranging one or more transition edges of control signals outside the duration that the second driving unit 26 receives image data, the driving circuit according to the invention can effectively reduce the probability that noise impulses at the ground node destroy image data. Even if the user request the display system 10 to flip images or the hardware arrangement of the driving circuits is changed, as long as the first driving unit 24 provides control signals with suitable timing sequences, the situation that image data is damaged can be prevented.

Similarly, by arranging transition edges of control signals outside the duration that the second driving unit 26 receives image data, the driving circuit according to the invention can also reduce the probability that noise impulses at the ground node destroy the control signals.

Another embodiment according to the invention is a display system including all the elements shown in FIG. 5(A). The operation of this display system is similar to the aforementioned embodiment and is not further described.

By suitably adjusting the timing sequence of control signals provided from the main driver to the auxiliary driver, the driving circuit according to the invention can prevent image data from being damaged. The concept according to the invention is applicable to not only source drivers with the function of timing control including two driving chips but also source drivers with the function of timing control including multiple driving chips.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A driving circuit for a display system, comprising:
a first driving unit for receiving N image data and driving the display system based on M image data among the N image data, N and M being positive integers, M being smaller than N; and
a second driving unit, electrically connected to the first driving unit, for receiving a set of control signals and the other (N−M) image data among the N image data from the first driving unit, the second driving unit driving the display system based on the set of control signals and the (N−M) image data;
wherein when the display system is in a first mode, the first driving unit provides the set of control signals to the second driving unit in a first timing sequence; when the display system is in a second mode, the first driving unit provides the set of control signals to the second driving unit in a second timing sequence.

2. The driving circuit of claim 1, wherein the first driving unit includes M first registers, the second driving unit includes (N−M) second registers; the first driving unit sequentially receives the N image data; when the display system is in the first mode, the first driving unit stores the preceding M image data among the N image data into the M first registers in a first duration and then provides the following (N−M) image data among the N image data to the second driving unit in a second duration; the second driving unit stores the (N−M) image data into the (N−M) second registers.

3. The driving circuit of claim 2, wherein if the first driving unit provides the set of control signals in the first timing sequence, the first driving unit arranges at least one transition edge of the set of control signals outside the second duration.

4. The driving circuit of claim 1, wherein the first driving unit includes M first registers, the second driving unit includes (N−M) second registers; the first driving unit sequentially receives the N image data; when the display system is in the second mode, the first driving unit provides the preceding (N−M) image data among the N image data to the second driving unit in a first duration; after the second driving unit stores the (N−M) image data into the (N−M) second registers, the first driving unit then stores the following M image data among the N image data into the M first registers in a second duration.

5. The driving circuit of claim 4, wherein if the first driving unit provides the set of control signals in the second timing sequence, the first driving unit arranges at least one transition edge of the set of control signals outside the first duration.

6. The driving circuit of claim 1, wherein the set of control signals includes a clock signal.

7. The driving circuit of claim 1, wherein the first driving unit includes a first control signal generating circuit and a second control signal generating circuit; the first control signal generating circuit is used for generating the set of control signals in the first timing sequence, the second control signal generating circuit is used for generating the set of control signals in the second timing sequence; when the display system is in the first mode, the first driving unit provides the set of control signals generated by the first control signal generating circuit to the second driving unit; when the display system is in the second mode, the first driving unit provides the set of control signals generated by the second control signal generating circuit to the second driving unit.

8. A display system, comprising:
N columns of display units;
a first driving unit, electrically connected to M columns of display units among the N columns of display units, for receiving N image data and driving the M columns of display units based on M image data among the N image data, N and M being positive integers, M being smaller than N; and
a second driving unit, electrically connected to the first driving unit and (N−M) columns of display units among the N columns of display units, for receiving a set of control signals and the other (N−M) image data among the N image data from the first driving unit, the second driving unit driving the (N−M) columns of display units based on the set of control signals and the (N−M) image data;
wherein when the display system is in a first mode, the first driving unit provides the set of control signals to the second driving unit in a first timing sequence; when the display system is in a second mode, the first driving unit provides the set of control signals to the second driving unit in a second timing sequence.

9. The display system of claim 8, wherein the first driving unit includes M first registers, the second driving unit includes (N−M) second registers; the first driving unit sequentially receives the N image data; when the display system is in the first mode, the first driving unit stores the preceding M image data among the N image data into the M first registers in a first duration and then provides the following (N−M) image data among the N image data to the second driving unit in a second duration; the second driving unit stores the (N−M) image data into the (N−M) second registers.

10. The display system of claim 9, wherein if the first driving unit provides the set of control signals in the first timing sequence, the first driving unit arranges at least one transition edge of the set of control signals outside the second duration.

11. The display system of claim 8, wherein the first driving unit includes M first registers, the second driving unit includes (N−M) second registers; the first driving unit sequentially receives the N image data; when the display system is in the second mode, the first driving unit provides the preceding (N−M) image data among the N image data to the second driving unit in a first duration; after the second driving unit stores the (N−M) image data into the (N−M) second registers, the first driving unit then stores the following M image data among the N image data into the M first registers in a second duration.

12. The display system of claim 11, wherein if the first driving unit provides the set of control signals in the second timing sequence, the first driving unit arranges at least one transition edge of the set of control signals outside the first duration.

13. The display system of claim 8, wherein the set of control signals includes a clock signal.

14. The display system of claim 8, wherein the first driving unit includes a first control signal generating circuit and a second control signal generating circuit; the first control signal generating circuit is used for generating the set of control signals in the first timing sequence, the second control signal generating circuit is used for generating the set of control signals in the second timing sequence; when the display system is in the first mode, the first driving unit provides the set of control signals generated by the first control signal generating circuit to the second driving unit; when the display system is in the second mode, the first driving unit provides the set of control signals generated by the second control signal generating circuit to the second driving unit.
